(19) United States
(12) Patent Application Publication
(10) Pub. No.: US 2019/0072319 A1
(43) Pub. Date: Mar. 7, 2019

(54) ASSEMBLY MODULE FOR A HOUSEHOLD COOLING APPLIANCE WITH A WATER FILTER AND A VALVE, AND HOUSEHOLD COOLING APPLIANCE

(71) Applicant: BSH-HAUSGERAETE GMBH, MUENCHEN (DE)

(72) Inventor: KARL-FRIEDRICH LAIBLE, LANGENAU (DE)

(21) Appl. No.: 15/696,677

(22) Filed: Sep. 6, 2017

(51) Int. Cl. F25D 23/12; C02F 1/00

(52) U.S. Cl. CPC F25D 23/126; C02F 1/003; C02F 2307/10; C02F 2201/005; C02F 2201/006; F25D 2323/121

(57) ABSTRACT

An assembly module for a household cooling appliance includes a water filter for filtering water externally from the household cooling appliance, a valve which is connected to the water filter in a fluid-conducting manner, a pipe for conducting the filtered water to the household cooling appliance, and a carrier plate on which the water filter and the valve are arranged. The assembly module is configured to be arranged outside a household cooling appliance. There is also described a system.

### TECHNICAL FIELD

The invention relates to an assembly module for a household cooling appliance and to a system with a household cooling appliance and an assembly module.

### BACKGROUND OF THE INVENTION

It is known that household cooling appliances can comprise a dispenser unit for dispensing liquid and/or ice form elements. Such a dispenser unit has to be connected to a water system to enable the supply of liquid such that the ice form elements to be generated can be formed from this liquid. The preparation of beverages which can be dispensed via the dispenser unit also potentially requires water, which has to be externally supplied. In this context it is known that a household cooling appliance comprises a water filter by which the externally supplied water is filtered. However, such a water filter requires adequate space.

In this context, EP 1635927 B1 teaches not to install the water filter in the housing of the device itself but in an empty space of the device which is formed beneath a bottom. To this end, the side walls of the device extend further down than the bottom such that the household cooling appliance itself comprises such a lower empty space, which is formed by the device itself. In this empty space, the water filter is arranged and arranged therein at a frontside grid, which is a component of the downwardly extending housing of the household cooling appliance.

Moreover, it is known that household appliances can also, for example, be arranged as built-in devices in a furniture wall such as a kitchen unit. In this context, an installation recess can provided in the furniture wall which is surrounded by further components of the furniture wall. In this connection, the household appliance can also directly adjoin the furniture wall and thus as it were constitute a lateral boundary of the furniture wall.

### SUMMARY OF THE INVENTION

It is the object of the present invention to enable a compact design of a household appliance and to arrange, according to requirements, a specific functional component of the household appliance outside the household appliance.

This object is solved by an assembly module and a system according to the independent claims.

A first aspect of the invention relates to an assembly module for a household cooling appliance. The assembly module comprises a water filter for filtering water externally from the household cooling appliance. The assembly module moreover comprises a valve which is connected to the water filter in a fluid-conducting manner. The assembly module further comprises a pipe for conducting the filtered water to the household cooling appliance. The assembly module also comprises a carrier plate on which the water filter and the valve are arranged. The assembly module is configured to be arranged outside a household cooling appliance.

A further aspect of the invention relates to a system with a household cooling appliance and an assembly module, as explained above.

Further features of the invention are apparent from the claims, the figures and the description of figures. The features and feature combinations mentioned above in the description as well as the features and feature combinations mentioned below in the description of figures and/or shown in the figures alone are usable not only in the respectively specified combination but also in other combinations, without departing from the scope of the invention. Thus, implementations are also to be considered as encompassed and disclosed by the invention, which are not explicitly shown in the figures and explained, but arise from and can be generated by separated feature combinations from the explained implementations. Implementations and feature combinations are also to be considered as disclosed, which thus do not comprise all of the features of an originally formulated independent claim. Moreover, implementations and feature combinations are to be considered as disclosed, in particular by the implementations set out above, which extend beyond or deviate from the feature combinations set out in the back-references of the claims.

### BRIEF DESCRIPTION OF THE DRAWINGS

Embodiments of the invention are explained in the following in more detail on the basis of schematic drawings. These show in:

FIG. 1 a perspective view of an embodiment of a system according to the invention;

FIG. 2 a perspective view of an embodiment of an assembly module; and

FIG. 3 a top view of the perspective according to FIG. 2.

### DETAILED DESCRIPTION OF PREFERRED EMBODIMENTS

In the figures identical or functionally identical elements are equipped with the same reference signs.

With indications “top”, “bottom”, “front”, “back”, “horizontal”, “vertical”, “depth direction”, “width direction”, “height direction” etc. the positions and orientations given in the case of intended use and intended arrangement of the assembly module are indicated.

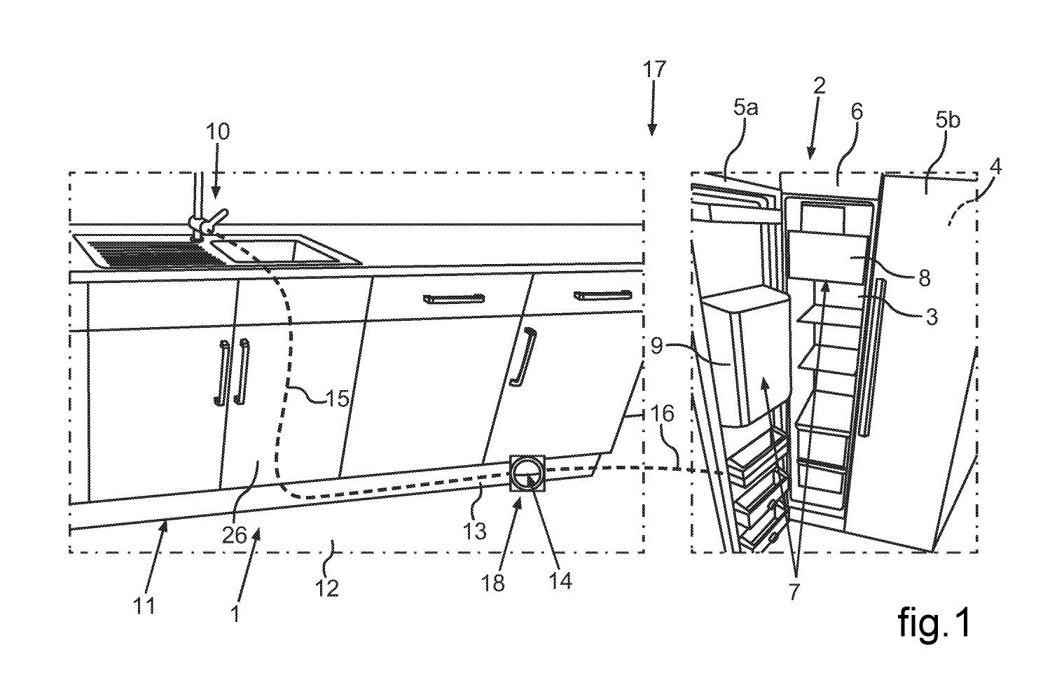

FIG. 1 shows in a schematic partial view a furniture wall 1, which is presently a kitchen unit. The furniture wall 1 further comprises a household cooling appliance 2 which, for the sake of enhanced presentation, is presently shown separately but which can also, for example, be arranged in an installation recess of the furniture wall 1 or adjoin furniture components as a lateral boundary of the furniture wall 1. The household cooling appliance 2 can be a built-in device. However, in this context, it can also be a floor-standing device.

The household cooling appliance 2 can be a refrigerator or a freezer or a fridge freezer. As shown in FIG. 1, it can comprise at least one receiving space 3 for food, which can be a refrigerator compartment or a freezer compartment. There can also be provided a household cooling appliance 2 which comprises at least two separate receiving spaces, of which one can be a refrigerator compartment and another a freezer compartment. In the illustrated embodiment, two such receiving spaces 3 and 4 are envisaged. The first receiving space 3 can be closed by a first door 5a of the household cooling appliance 2, which is pivotably arranged at a housing 6. The further receiving space 4 can be closed by a door 5b separate therefrom, which is presently shown in the closed position.

In one embodiment, the household cooling appliance 2 comprises a dispenser unit 7 which is configured to dispense liquid and/or ice form elements. In the illustrated embodiment, the dispenser unit 7 comprises an ice maker 8 which is configured to generate and produce ice form elements from liquid. The ice maker 8 is presently arranged in the housing 6. The dispenser unit 7 moreover comprises an output unit 9 which is formed in the door 5 and via which the liquid and/or ice form elements can be dispensed. For this purpose, the door 5 comprises a recess on an outer side facing away from the receiving space 3, into which a receptacle can be inserted so that the liquid and/or ice form elements dispensed via the output unit 9 can be collected.

To enable such output of liquid and/or ice form elements, it is required that the household cooling appliance 2 and in particular the dispenser unit 7 are externally supplied with water. For this purpose, the household cooling appliance 2 is connected to an external domestic water supply system 10. The furniture wall 1 comprises a furniture base 11. The furniture base 11 is arranged on a floor 12.

The furniture base 11 constitutes a lower boundary of the furniture elements and thus a lower boundary of furniture components of the furniture wall 1.

The furniture base 11 comprises a furniture part 13 which is formed as a continuous, hole-free plate. The furniture base 11 moreover comprises a water filter 14. The water filter 14 is configured to filter the water which is to be conducted from the domestic water supply system 10 to the household cooling appliance 2 via a pipe 15, presently shown schematically as a dashed line. In conventional household cooling appliances the water filter 14 is part of the household cooling appliance itself and configured to filter the water externally supplied to the household cooling appliance 2 before it reaches the dispenser unit 7. The filtered water is then conveyed to the dispenser unit 7, as illustrated by a further pipe 16 schematically drawn in as a dashed line. Thus, the filtering of the water is performed externally and remotely from the household cooling appliance 2 in the furniture base 11 itself. The water filter 14 is arranged at the furniture part 13. It is in particular non-destructively detachably arranged at the furniture part 13. By the water filter 14, filtering can be performed externally to the household cooling appliance 2.

Due to such an arrangement of the water filter 14, on the one hand a space-saving arrangement thereof spaced apart from the household cooling appliance 2 is enabled, while on the other hand the water filter 14 is easily accessible, for example for replacement or maintenance purposes. The water filter 14 is thus no longer arranged at the household cooling appliance 2, for example in an empty space, formed by side walls of the housing, underneath a bottom of the housing, but completely spaced apart from the housing 6. The arrangement of the furniture part 13 is in particular such that it is a frontside visible component which constitutes a lower border strip of the furniture wall 1. The furniture part 13 and thus likewise the furniture base 11 extend in a horizontal direction across a plurality of furniture elements of the furniture wall 1. Specifically, if the household cooling appliance 2 as a free-standing component directly laterally adjoins a side wall of the furniture wall 1, the furniture base 11 only extends as far as this side wall and in particular not below the household cooling appliance 2.

According to the illustration of FIG. 1, also a system 17 is formed which comprises the household cooling appliance 2 and the furniture base 11.

The furniture base 11 with the furniture part 13 and the water filter 14 together with a valve not yet shown in FIG. 1 constitutes an assembly module 18. The assembly module 18 is formed for the household cooling appliance 2. By the water filter 14, filtering of the water supplied by the pipe 15 is performed externally from the household cooling appliance 2.

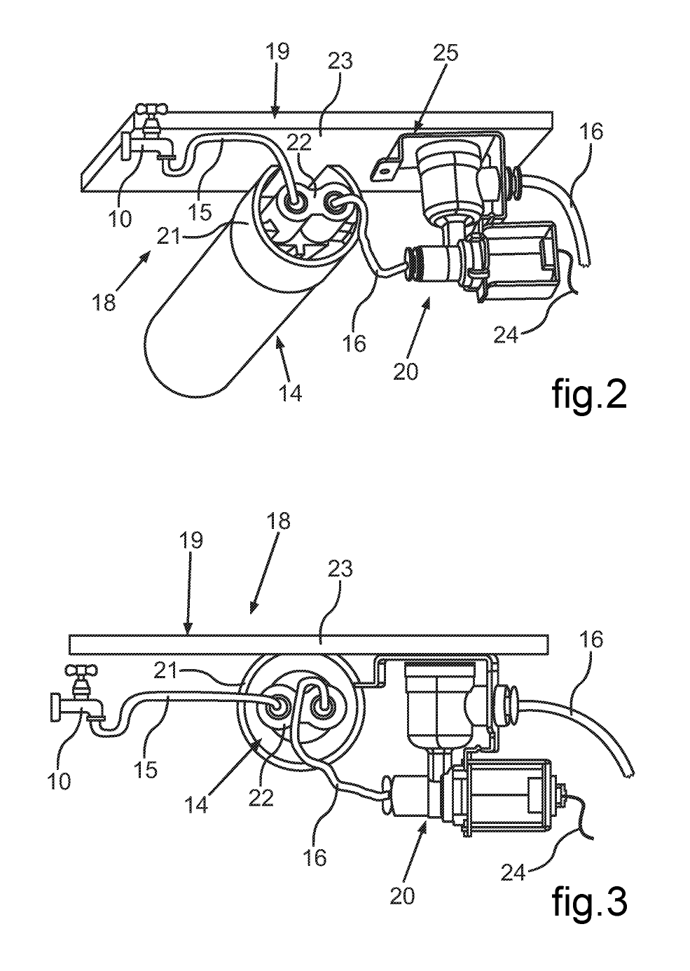

FIG. 2 shows in a perspective view an embodiment of an assembly module 18. Moreover, presently a portion of a carrier plate 19 is shown, which is in particular formed by the furniture base 11, specifically by the furniture part 13. However, in other embodiments the carrier plate 19 can be differently designed.

FIG. 2 also shows an example of a previously mentioned valve 20. The valve 20 is connected with the water filter 14 in a fluid-conducting manner via the pipe 16. The pipe 16 then leads from the valve 20 to the household cooling appliance 2. As can be seen, both the water filter 14 and the valve 20 are arranged at the carrier plate 19, which is in particular formed as a single piece. The assembly module 18 is arranged outside and spaced apart from the household cooling appliance 2 in the system 17, in particular the furniture wall 1. The carrier plate 19 is configured to connect the assembly module 18 with a component external to the household cooling appliance 2 such that the assembly module 18 is arranged outside the household cooling appliance 2. In the present context, the carrier plate 19 can be configured to provide a connection to another furniture element of the furniture wall 1.

In an advantageous embodiment, the assembly module 18 comprises a receiving shaft 21 configured to receive the water filter 14. The receiving shaft 21 is presently of pipe-like form and arranged at the carrier plate 19, in particular formed thereto in one piece. The water filter 14 extends into the receiving shaft 21 to be retained therein. Specifically, a filter head 22 of the water filter 14 extends into the receiving shaft 21 and is retained therein. The remaining area of the water filter 14 extends outside the receiving shaft 21. In the illustrated embodiment, the carrier plate 19 thus comprises a base plate 23 and the receiving shaft 21. The receiving shaft 21 is formed to the base plate 23, which is in particular level, on the rear side.

In an advantageous embodiment it is provided that the valve 20 is arranged at the base plate 23. Preferably, presently there can be provided a screw connection via a connection unit 25. FIG. 2 moreover shows an electric line 24 by which the valve 20 is supplied with electrical energy.

In an advantageous embodiment, it can be provided that the assembly module 18 is configured as an upgrade module for a system 17. Thus, a household cooling appliance 2, in particular a dispenser unit 7, can be externally supplied with water.

It can be provided that the system 17 comprises a further household appliance separate from the household cooling appliance 2, which can for example be a dishwasher. It can be provided that the assembly module 18 is arranged beneath the further household appliance. The system 17 is in particular arranged in the furniture wall 1.

Fastening options for fastening the carrier plate 19 to a further component, in particular a furniture body of the furniture wall 1, can be screw holes or latching hooks or insert lugs or the like. Advantageously, the electric line 24 directly leads to the household cooling appliance 2. This enables control of the valve 20 via a control unit which is internally arranged in the household cooling appliance 2.

Preferably the assembly module 18 is arranged in the area of a dishwasher, if such a dishwasher is present. This is shown exemplary in FIG. 1. There the assembly module 18 is arranged on the furniture part 13 directly under the dishwasher. Alternatively the assembly module 18 can be arranged in the area of a sink, if such a sink is present.

In FIG. 1 it is possible that the assembly module 18 is arranged directly under the sink, especially arranged on the furniture plate 13. In the area of the dishwasher as well as in the area of the sink a water-connection is plugged so that an appropriate connection of the assembly module 18 can be arranged.

### LIST OF REFERENCE SIGNS

1 furniture wall
2 household cooling appliance
3 receiving space
4 receiving space
5a door
5b door
6 housing
7 dispenser unit
8 ice maker
9 output unit
10 domestic water supply system
11 furniture base
12 floor
13 furniture part
14 water filter
15 pipe
16 pipe
17 system
18 assembly module
19 carrier plate
20 valve
21 receiving shaft
22 filter head
23 base plate
24 electric line
25 connection unit
26 furniture body

1. Assembly module for a household cooling appliance, comprising
a water filter for filtering water externally from the household cooling appliance,
a valve which is connected to the water filter in a fluid-conducting manner,
a pipe for conducting the filtered water to the household cooling appliance, and
a carrier plate on which the water filter and the valve are arranged, wherein the assembly module is configured to be arranged outside a household cooling appliance.

2. Assembly module according to claim 1, wherein the carrier plate is configured to connect the assembly module with a component external to the household cooling appliance 2 such that the assembly module is arranged outside the household cooling appliance.

3. Assembly module according to claim 1, wherein the water filter comprises a filter head, and the carrier plate comprises a receiving shaft for the filter head, into which the filter head extends.

4. Assembly module according to claim 3, wherein the receiving shaft is of pipe-like form.

5. Assembly module according to claim 3, wherein the receiving shaft is formed in one piece with a base plate of the carrier plate.

6. Assembly module according to claim 1, wherein the valve comprises a connection unit by which the valve is screwed to the carrier plate.

7. Assembly module according to claim 1, wherein the valve comprises an electric line by which the valve can be electrically connected to the household cooling appliance.

8. Assembly module according to claim 1, wherein the assembly module is configured as an upgrade module for upgrading a household cooling appliance.

9. System with a household cooling appliance and an assembly module, comprising
a water filter for filtering water externally from the household cooling appliance,
a valve which is connected to the water filter in a fluid-conducting manner,
a pipe for conducting the filtered water to the household cooling appliance, and
a carrier plate on which the water filter and the valve are arranged,
wherein the assembly module is arranged outside the household cooling appliance and connected to the household cooling appliance in a fluid-conducting manner.

10. System according to claim 9, wherein the household cooling appliance comprises a dispenser unit for dispensing liquid and/or ice, and the dispenser unit is connected to the assembly module in a fluid-conducting manner for conducting filtered water from the water filter to the dispenser unit.

11. System according to claim 9, wherein the system comprises a further household appliance, and the assembly module is arranged beneath the further household appliance.

12. System according to claim 11, wherein the further household appliance is a dishwasher.

13. System according to claim 10, wherein the system is installed in a furniture wall.

14. System according to claim 9, wherein a component at which the carrier plate of the assembly module is arranged is a furniture body or a furniture base of a furniture wall.
